(19) United States
(12) Patent Application Publication
(10) Pub. No.: US 2026/0283296 A1
(43) Pub. Date: Sep. 24, 2026

(54) FOOT MASSAGING SHOE

(71) Applicant: Rohon Roychoudhury, Bloomfield Hills, MI (US)

(72) Inventor: Rohon Roychoudhury, Bloomfield Hills, MI (US)

(21) Appl. No.: 19/571,252

(22) Filed: Mar. 18, 2026

Related U.S. Application Data
(63) Continuation-in-part of application No. 18/892,926, filed on Sep. 23, 2024, now Pat. No. 12,611,359.

(51) Int. Cl. A43B 3/40; A43B 7/1455; A43B 13/14; A61H 23/02; H02J 7/80; H02J 50/00; H02J 50/12; H02J 50/60

(52) U.S. Cl. CPC A43B 3/40; A43B 7/146; A43B 13/14; A61H 23/0254; H02J 7/80; H02J 50/005; H02J 50/12; H02J 50/60; A61H 2201/164; A61H 2201/165

(57) ABSTRACT

A wirelessly chargeable foot massaging shoe comprising a shoe upper and a sole defining an internal cavity. The cavity houses a massage mechanism including a servo motor and a massage pendulum with multiple lateral rods and massage balls. The pendulum rotates in a semicircular fashion to provide therapy to the plantar foot surface. Integrated within the sole is a custom printed circuit board (PCB) and a flexible wireless charging receiver coil configured to inductively receive power from an external transmitter. The PCB manages the charging of an internal rechargeable battery and regulates power delivery to the servo motor. A pushbutton switch soldered to the PCB allows for user-activated control of the massage mechanism. The charging system enables a fully sealed shoe exterior, protecting internal components from environmental hazards while eliminating the need for physical charging ports.

### CROSS-REFERENCE TO RELATED APPLICATIONS

This application is a continuation-in-part of U.S. patent application Ser. No. 18/892,926 filed on Sep. 23, 2024, the disclosure of which is incorporated by reference in its entirety.

### FIELD OF THE INVENTION

This disclosure generally relates to a foot massaging shoe that provides massage therapy for sore feet and plantar fasciitis, and more specifically to the stretching of the plantar fascia muscle generated by a massage pendulum that rotates about an axis in the shoe sole, out of and back into the sole while wearing the shoe. This disclosure also relates to a wireless charging system in which a receiver coil, integrated into a custom printed circuit board (PCB), receives alternating current (AC) from a wireless transmitter through the shoe sole to charge a rechargeable battery, also connected to the custom PCB and housed within the sole.

### BACKGROUND OF THE INVENTION

Prolonged periods of standing and engaging in high-impact activities such as running, jogging, and jumping are the predominant culprits behind foot discomfort and the onset of conditions like plantar fasciitis. Foot discomfort can further be exacerbated in the obese population as carrying excess body weight places additional stress on the feet. The soreness gets worse over time and impairs a person's ability to function, as well as develops a person's urge for a foot massage. Common treatments are orthotic shoe insoles; however, this treatment doesn't fully alleviate the problem as the plantar fascia muscle still remains stationary even with these added insoles during prolonged sitting or standing.

Hence there is a need to effortlessly stretch and thus massage the plantar fascia muscle during periods where the user undergoes excessive sitting, standing, or locomotion while wearing shoes to alleviate foot soreness, which when built up could lead to plantar fasciitis.

Foot massaging devices have been developed to stretch the foot muscles. But none of these muscle stretching devices are built into a wearable shoe, for alleviation of foot fatigue while the user is out in public. These devices are mainly stationary such that the user would have to return home to access the foot massage. But having access to a foot massage while out in public, inside the privacy of the user's own shoes, immediately when the urge for a massage arises, is preferable to having to wait to return home.

Korean Patent Application No. 20150057831A offers a magnetic vibratory insole mechanism to massage the shoe sole inside of a shoe, however it does not have the same force or precision into trigger points on the plantar surface of the foot. U.S. Pat. No. 10,188,172B1 to Jacob Wurtz discloses an insole with nodules of various heights and diameters that presses into the plantar foot surface during cadence, however these nodules are stationary, not providing the same force or precision into trigger points on the plantar surface of the foot. Korean Patent Application No. 20100082265A offers a foot massaging device consisting of rotating balls that contact the plantar foot and move in a circular motion. However, this device is stationary rather than built into a wearable, portable shoe.

It should be noted roughly seventy five percent of individuals have suffered from foot fatigue or foot pain at some point in their lives. Therefore, there is a need for immediate access to a foot massaging stretching mechanism in the convenience and privacy of one's own shoes to be accessed any time when the user is out in public.

A battery-powered foot-massaging shoe requires a reliable method of recharging the battery to power the internal servo motor once the battery is depleted. Supplying power through direct current (DC) via a physical charging port would necessitate an external outlet on the shoe, exposing the internal components to environmental hazards such as rain, snow, and dirt. Additionally, requiring the user to manually plug and unplug each shoe for every charge cycle creates unnecessary inconvenience, which compounds over time into a significant user burden. The inclusion of a visible charging port on each shoe also diminishes the overall aesthetic appeal of the footwear.

Accordingly, there is a need for a more convenient method of recharging the foot-massaging shoe's internal battery-one that reliably powers the servo motor while maintaining a fully sealed exterior surface to prevent the ingress of environmental substances through any physical openings.

While wireless charging systems are widely implemented across various electronic devices to enhance user convenience, no existing solution integrates a wireless charging system into a PCB embedded within a shoe sole for the purpose of conveniently recharging a battery that is responsible for powering an internal foot-massaging mechanism.

### SUMMARY OF THE INVENTION

In one aspect of the present invention, a foot massaging shoe is provided. The foot massaging shoe includes a sole. The sole includes a cavity and a motor. The motor is received in the cavity of the sole and includes a motor shaft. The foot massaging shoes further includes a pendulum. The pendulum is received in the cavity. The pendulum includes a main rod and at least a first lateral rod. The first lateral rod is operatively connected to the main rod and extends radially from a longitudinal axis of the main rod. The first lateral rod includes a first massage ball provided at a distal end of the first lateral rod. The main rod is operatively connected to the motor shaft and rotates about a longitudinal axis of the main rod upon energization of the motor such that the first massage ball moves upwardly out of the cavity to massage.

In further aspects of the present invention, a foot massaging shoe apparatus is provided. The shoe includes a servo motor, a servo controller, a rechargeable battery, a wireless charging receiver, and a push-button switch, wired together to form a closed circuit and placed inside their respective cavity portions of the sole of the shoe. The servo shaft of the servo motor is attached to an axial rotary metal main rod with three shorter perpendicular lateral rods coming off the axial rotary rod. A metal massage ball is attached or formed at each of the distal ends of these perpendicular lateral rods.

The servo motor controller is pre-programmed to rotate the servo motor's shaft when the push button switch is pressed. This then rotates the rotary metal main rod attached to the servo shaft, from an angle of 0 degrees to 180 degrees and back to 0 degrees continuously back and forth until the push button is pressed again. As the axial main rod rotates along the axis of the servo shaft, the three perpendicular shorter lateral metal rods with their respective metal massage balls at the end also rotate continuously back and forth from 0 to 180 degrees, moving in the shape of a semicircle.

The key feature of the shoe lies in the upward and sideways pressure created on the plantar foot surface generated by the force of the metal massage balls as the rotary axial main rod rotates from 0 to 180 degrees, back and forth. This combination of upward and sideways pressure on the plantar fascia muscle creates a stretching effect on the muscle, thus increasing the flexibility of the muscle as well as providing relief to the user from the massaging sensation generated.

Another key feature and advantage of the present invention is its ability to be worn as a regular shoe for when the circuit switch is turned off. The person can remain stationary, walk, jog, or run in the shoes while the switch is in the “OFF” position, thus having the three spheres be at an angle of either 0 or 180 degrees, completely submerged inside of the shoe sole in their respective rod cavity portions in the sole. Then, as need be, the person may press the push button to switch on the shoe to activate the servo motor and initiate the massaging process.

In another aspect of the invention, a wireless charging receiver coil is integrated into a custom PCB that has plug-in sockets for the servo motor and the battery pack. This wireless charging receiver is folded underneath the PCB to make it into a compact shape so as to take up less space in the shoe sole. This wireless charging receiver lies parallel with a thin layer of the shoe sole under it so as to separate the receiver from the external environment while also keeping it as close as possible to ground level in order to be in close proximity to and thus properly receive alternating current from the wireless charging transmitter below it.

In another aspect of the invention, the wireless charging integrated PCB is held in place in a cavity of the shoe sole with the same rectangular shape and dimensions. This cavity is bounded by the battery pack resting on an elevated platform behind it, the servo motor in its servo motor enclosure on one lateral side, the shoe sole with opening for the pushbutton switch on the opposite lateral side, and the shoe sole in front of and under it. This rectangular encapsulation of the PCB forms a cavity of the same size as the PCB, restricting the PCB's lateral, anterior, and posterior movement inside of the shoe. The PCB's connection to the battery pack and servo motor by the PCB's respective connector ports further restricts movement superiorly.

A key feature of the invention, the PCB embedded within the shoe sole cavity is safeguarded against vertical compression by being surrounded on all sides by components of greater height. Laterally, it is positioned between a servo mounted on an elevated platform of shoe sole material on one side and dense sole material on the other-both offering structural reinforcement. Anteriorly, the shoe sole rises above the PCB, while posteriorly, a battery pack situated on its own elevated platform forms a rear barrier. This spatial arrangement ensures the PCB remains recessed beneath all surrounding elements, effectively shielding it from being crushed during use.

Another key feature of the invention is the efficiency of the wireless charging receiver circuitry, battery charging circuitry, servo motor control circuitry and firmware, and pushbutton switch all integrated using a unique topology into one PCB. This drastically decreases the volume of electronics in the shoe relative to having separate PCBs for each of the distinct circuitry components, therefore increasing the shoe's durability and longevity.

Further features and advantages will appear more clearly on a reading of the following detailed description of the preferred embodiments, which is given by way of non-limiting examples only and with reference to the accompanying drawings. The application of this invention applies to foot wears such as casual sneakers, sandals, as well as formal dress shoes.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a right side view of the foot massaging shoe with the circular ON/OFF push button shown on the sole according to one embodiment of the present invention;

FIG. 2 is a top plan view of the isolated molded shoe sole without any of the electric circuitry components and sole cover;

FIG. 3 is a top plan view of the shoe sole with the electronic circuitry components including the ON/OFF push button switch, servo motor, servo motor controller, battery, and metal pendulum attached to the shaft of the servo motor;

FIG. 4 is a top plan view of FIG. 3 with the addition of a sole cover that is meant to form part of the sole platform in which the foot stands on, as well as to protect the electric circuitry beneath it from the foot;

FIG. 5 is a rear view of the shoe depicting three different time shots in motion of the metal pendulum rotating about the axis of the servo shaft, where the pendulum forms a 45-degrees, 90-degrees and 135-degree angle with the plane of the shoe sole;

FIG. 6 is a right side view of the foot massaging shoe with portions removed for illustrative purposes showing the pendulums 25 in the vertical 90-degrees position;

FIG. 7 is a top and left side perspective view of the foot massaging shoe without the sole cover and some other portions removed for illustrated purposes;

FIG. 8 illustrates from an isometric view a custom printed circuit board configured to receive wireless power, charge a lithium-ion battery, and control operation of a servo motor. There contains a pushbutton switch, connector port for the servo motor, connector port for the rechargeable Lithium ion battery, and wireless charging receiver connected at the top of the PCB, as it wraps around the side and folds under the PCB to be as close as possible to the bottom of the shoe to receive charge from the transmitter. A wireless power receiver circuit converts inductively received energy into a regulated DC output for a battery charging circuit, which manages charging parameters and provides status indication. A pushbutton-actuated MOSFET switch selectively connects the battery to a system voltage rail powering a microcontroller, which generates a control signal for the servo motor via an external connector;

FIG. 9 illustrates a top plan view of the custom printed circuit board of FIG. 8, showing the layout of the pushbutton switch 310, servo motor connector port 320, battery connector port and other surface-mounted components 330, the portion of the wireless charging receiver coil 340 attached to the top surface before it wraps around the edge, and the two soldering thru holes 350 for electrically connecting the wireless charging receiver coil to the circuit board;

FIG. 10 is a schematic circuit diagram of the custom printed circuit board shown in FIGS. 8 and 9, illustrating the electrical interconnections among a wireless charging receiver coil (WPC1) 340, a wireless power receiver integrated circuit 351, a lithium-ion battery charger 352, a pushbutton switch (SB1) 310 for activating system power, a microcontroller for generating control signals 354, a P-Channel MOSFET (VT1) 353, a connector (X1) for a servo motor 35 and a connector (X2) for the rechargeable battery pack 320;

FIG. 11 is a top plan view of the wireless charging transmitter printed circuit board according to an embodiment of the present invention, showing a USB Type-C connector port 315 for input power, four charge status indicator LEDs 325 configured to display the charge level of the lithium-ion battery on the wireless receiver side in 25% increments, a status LED 335 that flashes blue during active charging and flashes red to indicate a charging error or fault condition, and the wireless charging transmitter coil 345 connected to the PCB for inductive power transfer to the receiver coil in the foot massaging shoe assembly;

FIG. 12 is a schematic circuit diagram of the wireless charging transmitter printed circuit board shown in FIG. 11, illustrating the electrical interconnections for receiving input power via USB Type-C connector CON1B 315, generating a regulated supply with buck converter U1 360, powering a wireless power transmitter integrated circuit U3 362, driving the transmitter coil through full-bridge driver U4, and providing visual feedback via four charge-level indicator LEDs 325 showing 25% increments of the receiver-side battery charge, a multi-function status LED 335 for charging/active/fault indications, and additional status LEDs controlled by the transmitter IC;

FIG. 13 is a top plan view of the sole of the foot massaging shoe 70, illustrating the internal layout of the primary components for the wireless charging and massage system. The figure depicts the latching pushbutton switch 310 for user-activated power control, the battery connector port 320 mounted on the custom printed circuit board (PCB), the servo motor connector port 330 also on the PCB, and the wireless charging receiver coil leads 390 (FIG. 8) soldered directly to the custom PCB at through holes 350 and are folded underneath for electrical connection to the inductive charging circuitry. The wireless charging receiver coil 340 itself is attached to the underside of the PCB and therefore not visible in this top-down view. Positioned centrally are the servo motor 35 and the massage pendulum 25 affixed to the servo motor shaft, which generates the oscillatory motion for foot massage;

FIG. 14 depicts a pair of wirelessly chargeable shoes 70 placed directly on top of a dedicated wireless charging pad 365. The shoes 70 are positioned so that the wireless charging receivers 340 embedded in their soles align precisely just a few centimeters above the corresponding transmitters 345 integrated into the charging pad 365, ensuring efficient inductive power transfer to recharge the internal batteries. The charging pad 365 includes clear visual indicators for monitoring the process: a charge status LED 335 blinks blue while charging is actively occurring and remains steadily lit (fully on) once the shoe battery reaches complete charge. Additionally, four battery level LEDs 325 provide progressive feedback on capacity—one LED illuminates at approximately 25% charge, with successive LEDs lighting up as the battery fills (two at 50%, three at 75%, and all four solidly lit when the battery achieves 100% charge)—allowing the user to easily confirm alignment, track charging progress, and know when the shoes 60 are fully powered without needing to lift them from the pad; and

FIG. 15 is a functional block diagram illustrating the power flow and charging path in the wirelessly chargeable foot massaging shoe 70 according to the present invention. The diagram is divided into two main regions separated by a dashed line representing the boundary between the outside and inside of the shoe sole. On the left side (outside shoe sole), power originates from a power output source and flows sequentially through the wireless charging transmitter coil 345 to the wireless charging receiver coil 340, which is positioned in close proximity to enable inductive power transfer. On the right side (inside shoe sole), the received power is directed to the printed circuit board (charging circuit board), which regulates and manages the charging process for the 7.4V lithium-ion battery pack. The battery pack supplies electrical power to the servo motor 35 responsible for driving the foot massaging mechanism 25 with bidirectional arrows between the printed circuit board and battery pack indicating charging and monitoring functions.

### DETAILED DESCRIPTION OF THE INVENTION

It will be readily understood that the electric circuitry components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

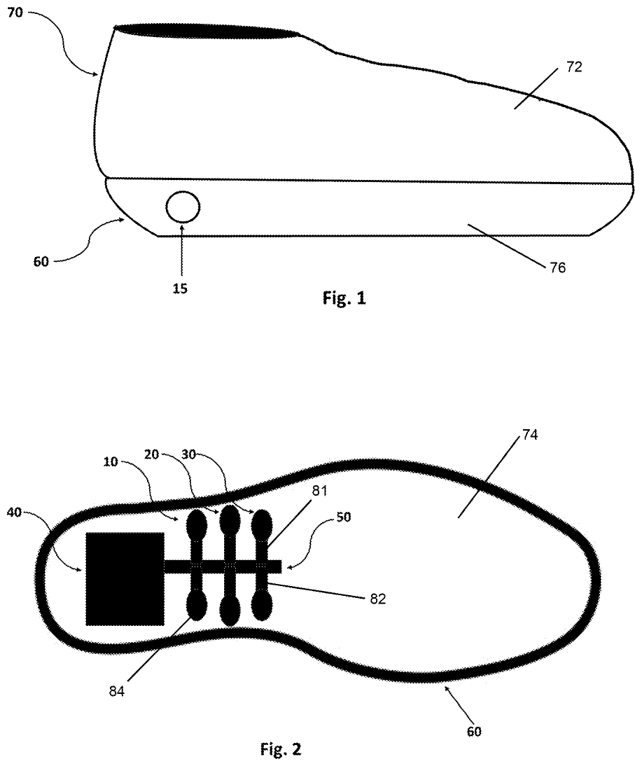

Throughout the present description, the terms “upper”, “lower”, “top”, “bottom”, “left”, “right”, “front”, “forward”, “rear”, and “rearward” shall define directions or orientations with respect to the foot massaging shoe as illustrated in FIG. 1, which shows a right side view of the foot massaging shoe with the circular ON/OFF push button shown on the sole. It will be understood that the spatially relative terms “upper”, “lower”, “top”, “bottom”, “left”, “right”, “front”, “forward”, “rear”, and “rearward” are intended to encompass different orientations of the apparatus in use or operation in addition to the orientation depicted in the figures. For example, if the apparatus in the figures is turned over, elements described as “upper” elements or features would then be “lower” elements or features.

In describing the preferred embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

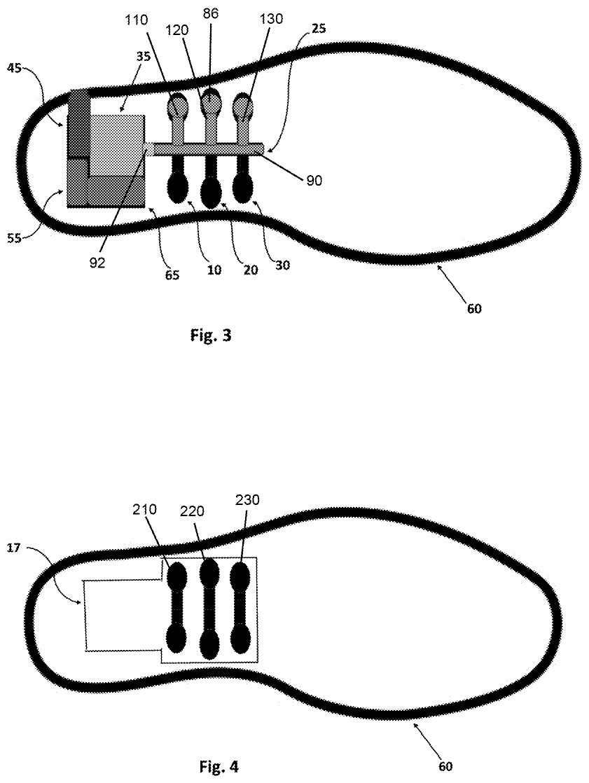

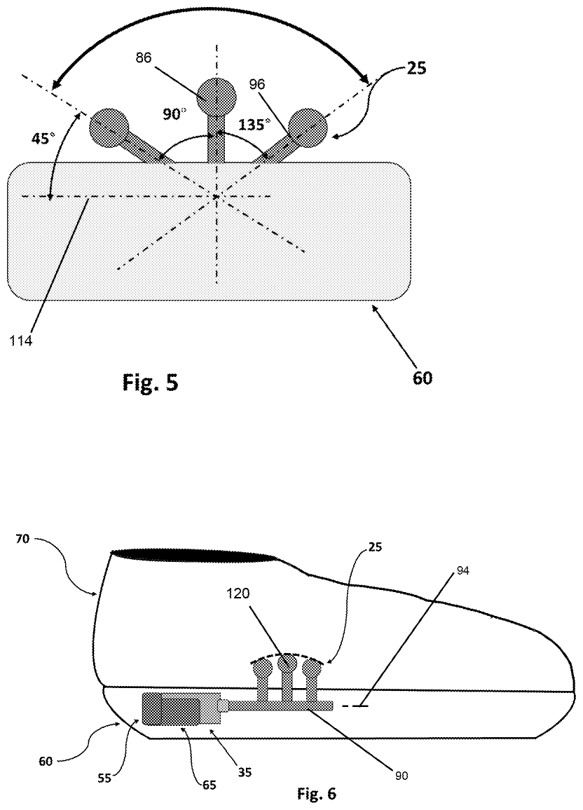

Referring now to FIGS. 1 and 2, the present invention in one embodiment comprises an electronic foot massaging shoe 70. The shoe 70 includes a sole 60, which is attached to a shoe top 72. The sole 60 includes an insole 74 (FIG. 2) and an outsole 76 (FIG. 1). As seen in FIG. 2, the insole 74 has a cavity 40 formed in the top of the insole 74 with cavity portions that allow for electric circuitry to fit within the cavity 40 entirely such that no part of the circuit rises above the level of a top insole plane 114 (FIG. 5) of the insole 74. The ON/OFF push button switch 45 (FIG. 3) is located at a side of the outsole 76 and has push button 15 (FIG. 1) with a button surface flushed with or at the same lateral surface as the surrounding outsole 76.

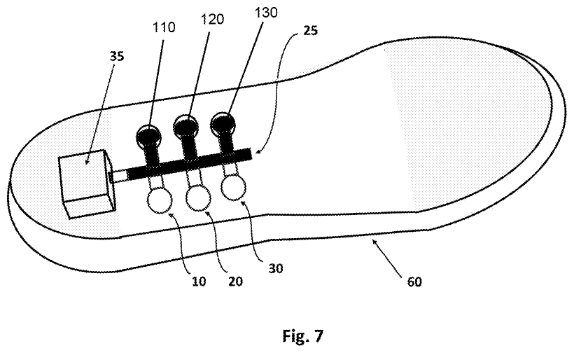

As seen in FIG. 2, the cavity 40 is continuous and has cavity portions that define compartments to allow for the compartmentalized fitting of a closed electric circuit along with a metal pendulum 25 (FIG. 3). The cavity 40 includes a main pendulum cavity portion 50 that extends along the longitudinal axis of the shoe 70. The cavity 40 further includes three lateral cavity portions 10, 20, and 30 that communicate and extend laterally from the main pendulum cavity 50. Each lateral cavity portion has first and second symmetrical sections 81, 82. Each symmetrical section 82 has a circular portion 84 to receive a steel massage ball 86 (FIG. 3) of its respective lateral rod 110, 120, 130 (FIG. 3). As seen in FIG. 7, the lateral cavity portions 10, 20, 30 span a length long enough to allow for the lateral rods 110, 120, 130 of the pendulum 25 to fit inside the cavity 40 at either the first or second section whether the pendulum 25 is at a 0-degree or 180-degrees position. The cavity 40 also receives a servo motor 35, the push button switch 45, a servo controller 55 and a battery 65. These components fit within the cavity 40.

FIG. 3 is the top plan view of the shoe sole 60 along with the electric circuitry placed with its components into their respective cavity portions. The ON/OFF push button switch 45, servo controller 55, battery 65, and servo motor 35 are connected by wires in a closed circuit. The battery 65 is electrically coupled to the servo controller 55 and supplies power to it and the servo motor 35 to energize the servo motor 35. The battery 65 may be a rechargeable battery. The servo controller 55 is electrically coupled to the servo motor 35 and controls the operation of the servo motor 35. The metal pendulum 25 includes a main rod 90 that is connected to and coaxial with a servo motor shaft 92. Energization of the servo motor 35 rotates the servo motor shaft 92, which in turn rotates the main rod 90 about its longitudinal axis 94 (FIG. 6). The three lateral rods 110, 120, 130 are connected to the main rod 90 and are oriented perpendicularly from the longitudinal axis 94 (FIG. 6) of the main rod 90. The lateral rods 110, 120, 130 extend radially outward from the main rod 90. Each of the lateral rods has its massage ball 86 formed on or otherwise attached to a distal end 96 (FIG. 5) of the lateral rod. The servo motor shaft 92 and thus pendulum 25 rotate continuously in a semicircular fashion back and forth from zero to one hundred and eighty degrees and then back from one hundred eighty degrees to zero when the push button 15 of the push button switch 45 is pressed and will stop rotating after the massage balls are positioned within the cavity 40 when the push button 15 of the push button switch 45 is pressed again.

FIG. 4 is a top plan view of the shoe sole 60 along with a sole cover 17 that fits onto the shoe sole 60 to act as both a barrier and a platform between the electric circuitry and the plantar surface of the foot that fits into the shoe 70. The sole cover 17 has three lateral slots or openings 210, 220, and 230 that are similarly shaped as and aligned with their respective three lateral cavity portions 10, 20, 30 of the cavity 40. The sole cover 17 may be removably attached to the insole 74 and cover the cavity 40 except at the three lateral openings 210, 220, 230. The three lateral openings 210, 220, 230 of the sole cover 17 allow the three metal massage balls 86 of the rotating pendulum 25 to move up through the three lateral openings and back down through the sole cover 17, for the purpose of making contact with the plantar foot surface.

FIG. 5 is a back view of the shoe sole 60 with the electric circuit held within the cavity portions of the shoe sole 60 to allow the rotating mechanism of the servo shaft to function. This figure represents three timeframes of the pendulum 25. The lateral rods 110, 120, 130 and the horizontal top insole plane 114 (as viewed in FIG. 5) of the shoe sole 60 form an angle of 45-degrees, 90-degrees, and 135-degrees. At the 90-degree position the massage balls 86 of the lateral rods 110, 120, 130 protrude at the maximal possible distance above the level of the shoe insole plane 114, producing the greatest pressure onto the plantar surface of the user's foot, before then decreasing in pressure on the foot as the pendulum rotates back to the level of becoming parallel with the shoe insole plane 114.

FIG. 6 is a side view of the shoe showing the pendulum 25 in the vertical 90-degrees position. The heights of the three lateral rods 110, 120, 130 of the pendulum 25 form an arc, with the tallest lateral rod 120 in the center, to capture the foot arch profile. The massage balls 86 at the distal end 96 of the lateral rods 110, 120, 130 of the pendulum 25 can be spring loaded to accommodate various foot profiles.

In operation, the entire pendulum 25 fits within the cavity 40 with the lateral rods 110, 120, 130 fitting within their respective first symmetrical sections 81 of the lateral cavity portions 10, 20, 30 in a stationary position as shown in FIG. 7. Upon a user pushing the push button 15, the push button switch 45 closes and connects the battery 65 to the servo controller 55 to supply power to the servo controller 55 and servo motor 35 to energize the servo motor 35 to rotate the pendulum 25 continuously in a semicircular fashion back and forth. In essence, the pendulum 25 may rotate clockwise (viewed from FIG. 5) from zero to one hundred and eighty degrees and then back counterclockwise from one hundred eighty degrees to zero.

Alternatively, the pendulum 25 may have its lateral rods 110, 120, 130 fit within their respective second symmetrical sections 82 of the lateral cavity portions 10, 20, 30 in the stationary position. In this alternative version, upon a user pushing the push button 15, the pendulum 25 may first rotate counterclockwise one hundred and eighty degrees and then back clockwise one hundred and eighty degrees. During either rotation of the pendulum 25, the three metal massage balls 86 of the rotating pendulum move up through the three openings 210, 220, 230 of the sole cover 17 and contact the bottom plantar surface of the foot of a user to massage it, and then they go back down through the openings 210, 220, 230 of sole cover 17 into the their respective circular portions 84 of the cavity 40. When the push button 15 of the push button switch 45 is pressed again, the pendulum 25 is moved to a position within the cavity 40 and stops rotating.

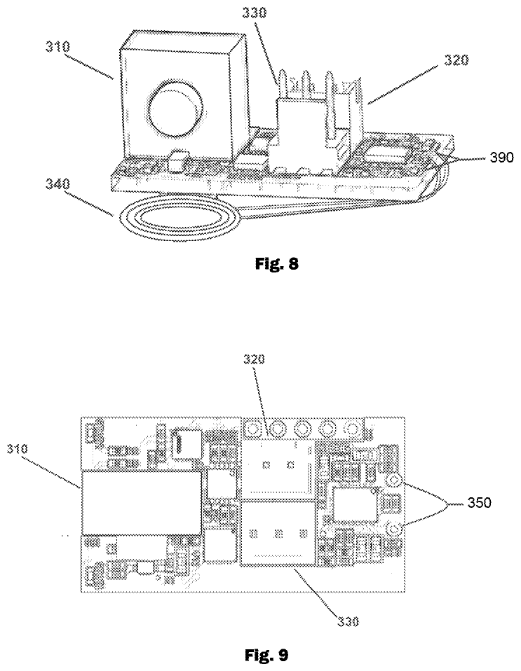

FIG. 8 is a perspective isometric view of an embodiment of the custom printed circuit board (PCB) assembly of the present invention, configured for integration into a foot massaging shoe to provide wireless charging, battery management, and servo motor control. The PCB assembly includes a pushbutton switch 310 protruding upward from the top surface of the board, the switch being positioned for user actuation through the shoe sole and having integrated leads soldered directly to corresponding pads on the PCB. Adjacent to the pushbutton switch are a battery connector port 320 and servo motor connector port 330, including a microcontroller, wireless power receiver integrated circuit, battery charger integrated circuit, MOSFET power switch, status LEDs, and supporting passive components.

A flexible wireless charging receiver coil 340 is electrically connected to the PCB, with a first portion of the coil attached to or positioned adjacent to the top surface of the PCB, the coil extending outwardly from one edge of the PCB, wrapping around the side edge, and folding underneath the bottom surface of the PCB. This folded configuration positions the majority of the coil 340 as close as possible to the sole of the shoe, thereby maximizing inductive coupling efficiency with an external wireless charging transmitter placed beneath the shoe. The custom PCB assembly is compact and contoured to fit within the limited space of a shoe insole or midsole region, with the folded receiver coil 340 enabling optimal alignment for wireless power transfer while maintaining a low overall profile. The circuit on the PCB receives inductively received AC energy via the coil leads 390 of coil 340, which are soldered at two through holes 350 (FIG. 9), rectifies and regulates it for charging a rechargeable lithium-ion battery (connected via a separate battery connector), and, upon actuation of the pushbutton switch 310, supplies power to the microcontroller for generating servo control signals output through connector 330.

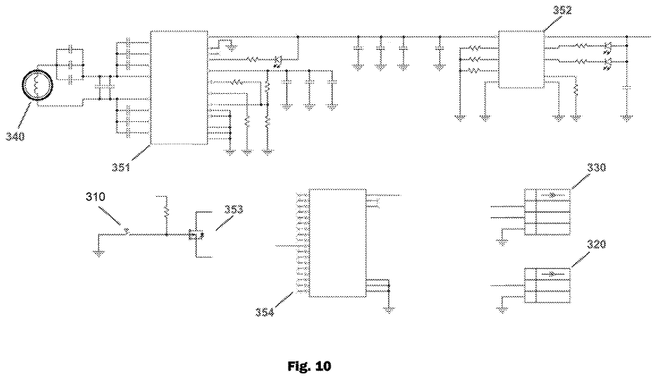

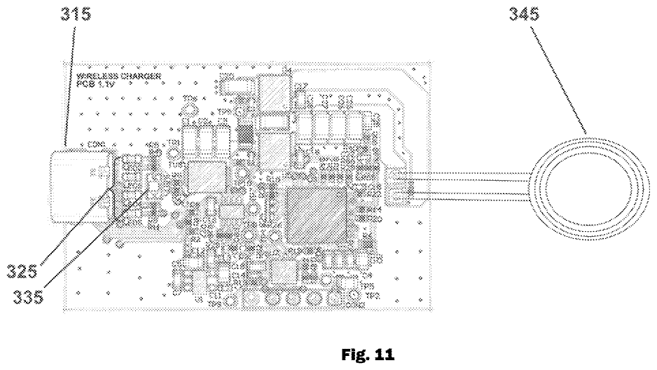

FIG. 10 is a schematic circuit diagram of the custom printed circuit board assembly illustrated in FIGS. 8 and 9. The circuit includes the wireless charging receiver coil (WPC1) 340 (part number 760308103206) connected at terminals AC1 and AC2 to a wireless power receiver integrated circuit 351 (BQ51013BRHLT). A resonant capacitor network comprising parallel capacitors C14-C19 and series capacitors C6-C7, together with clamping, communication, and supporting components (including D1, R3, R6, R8-R11, etc.), is configured in accordance with the recommended application for 351. 351 rectifies the inductively received AC energy, provides regulated communication signals via COMM1 and COMM2 for power transfer control, and outputs a rectified voltage (RECT) used for battery charging, with current limited to approximately 1 A via the ILIM configuration.

A battery charger section centered on 352 (BQ25171QWDRCRQ1) receives the regulated output from 351, manages charging of a rechargeable lithium-ion battery pack connected via connector X2 320 (VBATT and GND pins), and supports timer-disabled lithium chemistry with IMAX approximately 0.8 A. Charging status is indicated by open-drain outputs STAT1 and STAT2 driving green LED VD1 and red LED VD3 through current-limiting resistors R2 and R5, respectively, with additional yellow indication VD2 during active wireless power reception. System power is controlled by a latching pushbutton switch SB1 310 whose integrated leads are connected to the gate of a P-channel MOSFET VT1 353 (DMP3036SFG-7 or equivalent), allowing battery voltage VBATT to be selectively supplied to the system rail VSYS when the button is pressed and latched under microcontroller control.

A stable system voltage (VSYS≈5.0 V) is generated from the wireless power receiver (D1) when Qi charging is active, with filtered output via capacitors C2-C5. The microcontroller 354 is powered directly from VSYS and generates a PWM-capable servo control signal (SIGNAL) output via connector X1 330 pin 1, with VSYS supplied to X1 pin 2 and GND to X1 pin 3 for direct connection to a standard three-wire servo motor.

A low-dropout regulator U1 provides a stable +3.3 V supply (+3.3VD) from VSYS for digital circuitry. A microcontroller U2 is powered from +3.3VD and generates a PWM-capable servo control signal (SIGNAL) output via connector X1 pin 1, with VSYS supplied to X1 pin 2 and GND to X1 pin 3 for direct connection to a standard three-wire servo motor. Additional components include decoupling and filtering capacitors, pull-up/pull-down resistors, and supporting networks for stable operation of the wireless receiver, charger, power switch, regulator, and microcontroller. This circuit enables wireless inductive charging of the battery pack, pushbutton-initiated power-up of the system, and microcontroller-driven servo actuation for foot massaging functionality, all within a compact custom PCB suitable for integration into a shoe assembly.

FIG. 11 is a top plan view of the wireless charging transmitter printed circuit board (PCB) assembly of the present invention, configured to inductively transmit power to the receiver coil in the foot massaging shoe assembly. The transmitter PCB includes a USB Type-C input connector 315 positioned along one edge of the board, providing a power input port (typically 5V) for connection to an external USB power source or charger. Adjacent to the connector 315 are various surface-mounted components, including a buck converter or regulator, a wireless power transmitter controller integrated circuit, a full-bridge driver, power MOSFETS, and supporting passive components such as resistors, capacitors, inductors, test points, and additional integrated circuits distributed across the board for power management, communication modulation, and LED drive circuitry.

Four charge status indicator LEDs 325 are positioned near the USB connector 315, arranged to visually display the charge level of the lithium-ion battery on the remote receiver side (in the shoe) in 25% increments, with the LEDs selectively illuminated based on feedback signals received from the receiver via in-band communication during wireless power transfer. A multi-function status LED 335 is located adjacent to the charge status LEDs 325, configured to flash blue during active charging operation and to flash red in the event of a charging error, fault condition, or foreign object detection.

The wireless charging transmitter coil 345 is electrically connected to the PCB via multiple leads extending from one edge of the board. The coil 345 is a flat spiral inductor positioned externally to the main PCB body, allowing flexible placement of the transmitter assembly (e.g., within a charging mat or dock) while maintaining optimal alignment with the folded receiver coil in the shoe for efficient inductive power transfer. Additional connectors (e.g., CON1, CON2) and test points are provided for programming, debugging, or auxiliary functions. The compact layout of the transmitter PCB optimizes component placement for minimal size, efficient heat dissipation, and reliable Qi-compatible wireless power delivery to the custom receiver PCB represented in FIGS. 8-10.

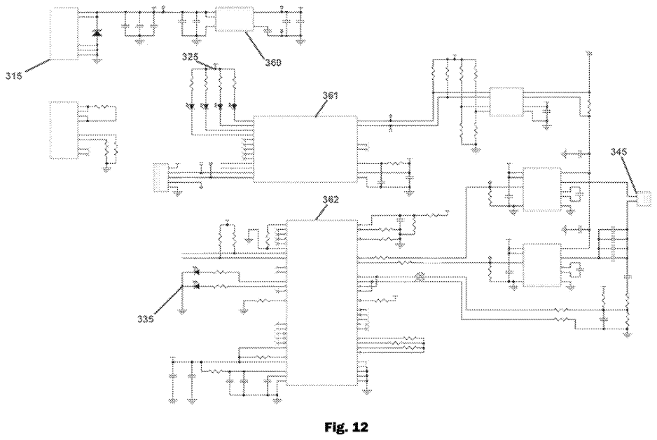

FIG. 12 is a schematic circuit diagram of the wireless charging transmitter printed circuit board assembly illustrated in FIG. 11. The circuit receives input power through USB Type-C connector CON1B 315, with VBUS protected by TVS diode and filtered via capacitors before being applied to low-dropout regulator U1 360 (TLV70033DDC), which generates a stable +3.3 V rail +3.3VD for powering the digital and control circuitry. Microcontroller 361 (STM32C011F4U6TR) serves as the primary controller, managing wireless power transfer protocol, communication modulation, LED status indication, and system configuration via pins such as PAO-PA8, PB6-PB7 (SCL/SDA for I2C debugging), and various RESERVED/CLK_DBG/DATA_DBG lines. The microcontroller interfaces with Qi-compliant wireless power transmitter controller U3 362 (BQ500212A or equivalent), providing clock (CLK_DBG), data (DATA_DBG), and control signals while monitoring status lines such as COMM_A+, COMM_B+, T_SENSE, PEAK_DET, V_SENSE, I_SENSE, and FOD-related inputs.

The transmitter controller U3 362 drives a full-bridge power stage implemented with half-bridge drivers U4 and U5, which in turn energize the external transmitter coil connected via connector CON3. Supporting components include bootstrap capacitors, sense resistors, current sense amplifier (e.g., INA219A or integrated), peak detection circuitry, and programming resistors for FOD and PMOD thresholds connected to LOSS_THR, as well as temperature sense. In-band communication with the receiver is facilitated through modulation of the coil voltage detected on COMM_A±/COMM_B±, allowing the transmitter to receive packet data from the shoe-mounted receiver regarding battery charge level, power needs, and error conditions. The microcontroller 361 decodes this information to control four charge status LEDs 325, illuminating them sequentially to indicate receiver-side battery charge in 25% increments as shown in the LED status table.

A multi-function status LED 335 (bi-color combination of blue LED1B and red LED1A) provides visual feedback: flashing blue during active power transfer, solid or flashing red for faults, slow blink for standby, on for charge complete, blink slow/fast for dynamic power limiting or FOD warning per the table. Additional features include programmable FOD and loss thresholds, PMOD configuration, snooze/sleep modes, reset, and multiple test points (TP1-TP10) for debugging and calibration. Pull-up/pull-down resistors, decoupling capacitors, and supporting networks ensure stable operation. This circuit enables Qi-compatible wireless power transmission from an external USB-powered base to the folded receiver coil in the foot massaging shoe, while providing detailed visual feedback of remote battery charge progress and system status through LEDs 325 and 335.

A key feature of the transmitter circuit is its ability to provide visual indication of the remote receiver-side battery charge level through four charge status LEDs 325—without requiring Bluetooth or any additional wireless communication technology. During wireless power transfer, the receiver in the shoe modulates the load on the transmitter coil in accordance with the Qi protocol to communicate its battery state-of-charge. This modulation is detected by the transmitter controller U3 via the COMM_A and COMM_B lines and decoded by the microcontroller U2. As the receiver battery approaches full charge, the power demand decreases (i.e., the AC current flow through the transmitter coil reduces). The microcontroller interprets the received charge-state packets and accordingly illuminates one to four of the LEDs 325 in 25% increments (e.g., one LED for 0-25%, two LEDs for 26-50%, three LEDs for 51-75%, and four LEDs for 76-100%), thereby providing the user with a direct visual indication of the foot massaging shoe battery charge progress without requiring any wired connection or additional display on the shoe itself.

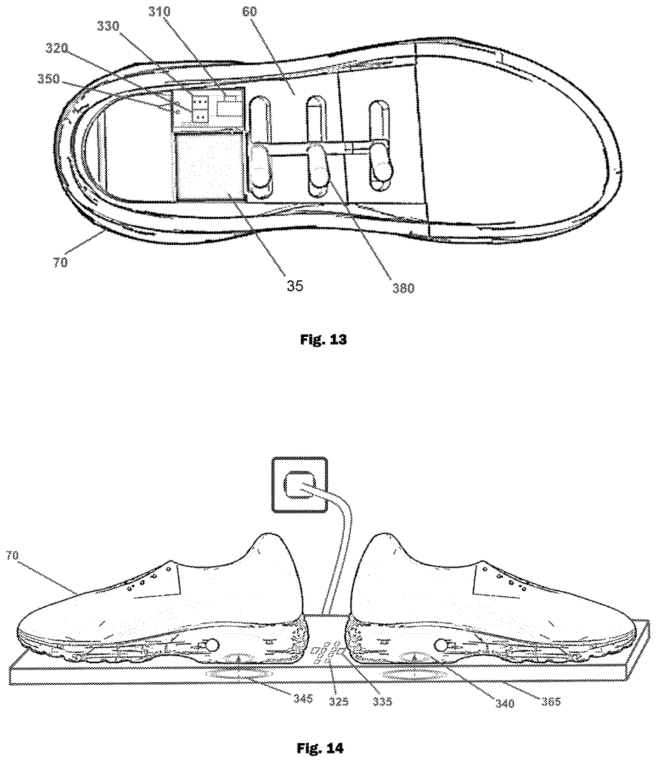

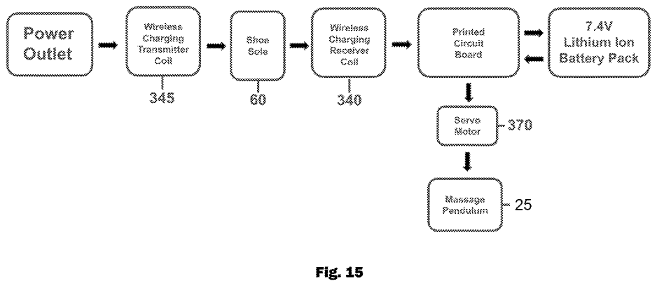

FIG. 13 is a top plan view of the sole 60 of the foot massaging shoe 70 according to one embodiment of the present invention, showing the internal layout of the wireless charging and oscillatory massage components. The sole 60 is illustrated from a top-down perspective, exposing the midsole/insole cavity of the shoe 70. The latching pushbutton switch 310 is positioned forward for user on/off control. Mounted nearby on the custom printed circuit board (PCB) are the battery connector port 320 for connection to a rechargeable battery (not shown) and the servo motor connector port 330 for power and control signal delivery to the servo motor. The wireless charging receiver coil leads 390 (FIG. 8) are shown as solder points on the PCB, providing electrical connection to the receiver coil, which is affixed to the underside of the PCB and thus not visible in this view. This arrangement enables inductive charging from an external transmitter pad.

Centrally and rearwardly located is the servo motor 35, securely mounted within the sole. Attached to the servo motor shaft is the massage pendulum 25, an eccentric mass element configured to rotate back and forth between approximately 0° and 180°. This controlled oscillatory motion pushes into and stretches the arch of the user's foot sole, delivering a mechanical massage effect. The components are compactly integrated primarily in the midfoot to forefoot region for balanced weight distribution and efficient operation, enclosed within the sole material, securing means to ensure durability during use. This figure illustrates the self-contained, cordless design integrating wireless inductive charging (via underside coil and visible leads 390) with a servo-driven pendulum mechanism for targeted arch massage.

FIG. 14 provides a detailed illustration of a pair of wirelessly chargeable shoes strategically positioned atop a compact wireless charging pad designated as element 365. The shoes are placed side by side on the flat surface of the pad, ensuring precise alignment between the integrated wireless charging receivers 340 embedded within each shoe's sole 60 and the corresponding inductive charging transmitters 345 built into the charging pad. This alignment positions the receivers only a few centimeters directly above the transmitters, optimizing the electromagnetic field coupling necessary for efficient, contactless power transfer to replenish the internal rechargeable batteries housed in the footwear.

To deliver clear and intuitive user feedback during the charging process, the charging pad incorporates a set of strategically placed LED indicators. The primary charge status LED, labeled 335, is prominently featured and functions as follows: it blinks blue in a regular pattern to visually confirm that active wireless charging is underway, then transitions to a steady, continuous illumination (fully on) once the shoe's battery has reached 100% capacity, signaling that charging is complete and the shoes can be safely removed. Complementing this, a row of four distinct battery level LEDs 325 offers granular insight into the current state of charge. These LEDs activate progressively: a single LED lights up when the battery reaches approximately 25% capacity, two LEDs illuminate at roughly 50%, three at 75%, and all four remain solidly lit when the battery achieves full charge. This progressive lighting scheme allows the user to monitor charging progress at a glance without disturbing the shoes' placement on the pad, while the overall design ensures reliable alignment verification, real-time status updates, and a seamless, user-friendly recharging experience for these innovative footwear items.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above-described embodiments, method, and examples, but by all embodiments and methods within the scope and spirit of the invention.

What is claimed is:

1. A wirelessly chargeable foot massaging shoe comprising:
a shoe upper and a sole defining an internal cavity;
a massage mechanism disposed within the internal cavity, the massage mechanism including a servo motor and a massage pendulum operatively coupled to a shaft of the servo motor;
a rechargeable battery disposed within the internal cavity; and
a wireless charging receiver system integrated into the sole, the wireless charging receiver system comprising a printed circuit board electrically coupled to the rechargeable battery and the servo motor, and a wireless charging receiver coil electrically connected to the printed circuit board, wherein the wireless charging receiver coil is configured to inductively receive power from an external transmitter to charge the rechargeable battery, and wherein the printed circuit board manages power delivery from the rechargeable battery to the servo motor to drive the massage pendulum.

2. The wirelessly chargeable foot massaging shoe of claim 1, wherein the wireless charging receiver coil comprises a flexible coil that extends from a top surface of the printed circuit board, wraps around a side edge of the printed circuit board, and is folded underneath a bottom surface of the printed circuit board to maximize proximity to a bottom surface of the sole.

3. The wirelessly chargeable foot massaging shoe of claim 1, further comprising a pushbutton switch soldered directly to the printed circuit board and positioned for user actuation through a portion of the shoe to selectively activate the servo motor.

4. The wirelessly chargeable foot massaging shoe of claim 1, wherein the printed circuit board is recessed within the internal cavity at a height lower than the servo motor and the rechargeable battery, such that the servo motor and rechargeable battery provide structural shielding for the printed circuit board against vertical crushing forces.

5. The wirelessly chargeable foot massaging shoe of claim 1, wherein the sole and shoe upper form a fully sealed exterior surface devoid of physical direct current charging ports, thereby preventing the ingress of environmental contaminants into the internal cavity.

6. The wirelessly chargeable foot massaging shoe of claim 1, wherein the printed circuit board further comprises a wireless power receiver integrated circuit, a battery charger integrated circuit, and a microcontroller configured to generate pulse-width modulation signals to control the oscillatory motion of the massage pendulum.

7. The wirelessly chargeable foot massaging shoe of claim 1, wherein the massage pendulum comprises a main rod connected to a plurality of lateral rods, each of the lateral rods having a massage ball formed at a distal end.

8. The wirelessly chargeable foot massaging shoe of claim 7, wherein the massage balls are configured to move upwardly out of the internal cavity to contact a plantar surface of a wearer's foot during rotation of the massage pendulum.

9. The wirelessly chargeable foot massaging shoe of claim 1, wherein the wireless charging receiver system is configured to communicate battery charge status data to an external transmitter via in-band communication through the wireless charging receiver coil.

10. The wirelessly chargeable foot massaging shoe of claim 1, further comprising a low-dropout regulator configured to provide a stable digital supply voltage to the microcontroller from a system power rail.

11. A wireless charging transmitter pad for a foot massaging shoe, the transmitter pad comprising:
a housing defining a flat top surface for receiving a shoe;
a transmitter printed circuit board disposed within the housing;
a transmitter coil electrically connected to the transmitter printed circuit board and positioned beneath the flat top surface; and
a plurality of charge status indicators configured to display a charge level of a remote battery within the shoe in twenty-five percent increments based on feedback signals received from the shoe, wherein the transmitter printed circuit board includes a microcontroller configured to decode load modulation signals from the shoe to determine the charge level without a secondary wireless communication protocol.

12. The wireless charging transmitter pad of claim 11, further comprising a multi-function status light emitting diode configured to flash a first color during active power transfer and a second color to indicate a foreign object detection fault.

13. The wireless charging transmitter pad of claim 11, further comprising a USB Type-C input connector for receiving power from an external power source.

14. The wireless charging transmitter pad of claim 11, wherein the transmitter printed circuit board includes a full-bridge driver configured to energize the transmitter coil.

15. The wireless charging transmitter pad of claim 11, wherein the plurality of charge status indicators are light emitting diodes arranged in a row adjacent to a power input port of the housing.

16. An integrated power management and control circuit for a foot massaging shoe comprising:
a charging circuit board having a wireless power receiver integrated circuit and a battery charging integrated circuit;
a wireless charging receiver coil electrically coupled to the charging circuit board;
a microcontroller disposed on the charging circuit board and programmed to monitor the voltage of a connected lithium-ion battery; and
a motor connector port disposed on the charging circuit board and configured to provide control signals to an external servo motor, wherein the microcontroller is configured to modulate the wireless charging receiver coil to transmit battery capacity data to an external charging source for visual display.

17. The integrated power management and control circuit of claim 16, wherein the charging circuit board includes at least two soldering thru-holes configured to secure the leads of the wireless charging receiver coil.

18. The integrated power management and control circuit of claim 16, further comprising a buck converter configured to generate a regulated supply voltage for the wireless power receiver integrated circuit.

19. The integrated power management and control circuit of claim 16, wherein the microcontroller is further configured to detect a charge-complete status and terminate power intake from the wireless charging receiver coil.

20. The integrated power management and control circuit of claim 16, wherein the charging circuit board includes a dedicated status indicator light configured to display a local charging status within the shoe.
